(19) United States
(12) Patent Application Publication
(10) Pub. No.: US 2012/0271675 A1
(43) Pub. Date: Oct. 25, 2012

(54) DYNAMIC CANDIDATE ORGANIZATION SYSTEM

(75) Inventors: Matt Christensen, Niagara Falls, NY (US); John Kruper, Evanston, IL (US); Jacob Champness, Nederland, CO (US); Adam Zamora, Park Ridge, IL (US)

(73) Assignee: ALPINE ACCESS, INC., Denver, CO (US)

(21) Appl. No.: 13/451,334

(22) Filed: Apr. 19, 2012

Related U.S. Application Data
(60) Provisional application No. 61/477,090, filed on Apr. 19, 2011.

(51) Int. Cl. G06Q 10/06; G06F 15/16

(52) U.S. Cl. 705/7.14

(57) ABSTRACT

One embodiment includes a dynamic candidate queuing system. The dynamic candidate queuing system includes a network comprising a server communicatively coupleable with one or more other computers. The server includes a processor and a storage device coupled to the processor. The server is configured to receive data entered at the one or more other computers by candidates and store the data in the storage device. Further, the processor generates a queue listing of candidates in the storage device and the queue listing is organized according to a score given to the data.

### CROSS-REFERENCE TO RELATED APPLICATIONS

This application claims priority to U.S. Provisional Patent Application No. 61/477,090, filed Apr. 19, 2011, and entitled, “Dynamic Candidate Queue System,” which is incorporated herein by reference in its entirety and for all purposes.

### TECHNICAL FIELD

The present application is directed to job recruiting systems and, more particularly, to job recruiting systems and methods that dynamically organize queues or tiers populated with candidates.

### BACKGROUND

Businesses seeking to fill vacant positions spend significant time, energy and money to recruit and properly place qualified candidates. Despite all the effort directed to finding “the right person,” under conventional systems and procedures, it is difficult to tell if a particular candidate will excel and/or remain in a particular position if hired. Often it is only after the employee has been placed into a vacant position that any quantifiable judgment as to whether skills and personality are a good fit. A “bad fit” may result in frustration for the employee and the management. Additionally, if the employee leaves after only a short period, more time, energy and money must be expended to again fill the position.

Many businesses may incorporate a semi-automated process for recruiting purposes. For example, they may have a website or other computing system to receive and scan/review resumes. Additionally, they may provide a relatively basic set of screening questions for a candidate to complete that may be used to screen the candidate for certain positions. Typically, the screening process is simply a binary process that determines if a particular candidate meets a requirement for the position or not. As such, it is likely that some generally qualified candidates may be screened out of consideration for a position or that a generally less qualified candidate may pass the screening process for that position.

### SUMMARY

A dynamic queuing system for job placement is presented that ranks and sorts candidates hierarchically based on a score achieved by the candidate answering questions and/or based on the candidate behavior (e.g., performance /activity in an online course, voice quality, recorded and assessed voice auditions, and so forth). One embodiment includes a ranking based solely on the test score. In other embodiments, a multi-variant score is provided based on weighted answers to the questions. Additionally, in some embodiments, non-behavioral factors may be accounted for, such as a “freshness” variable to modify the scoring. For example, a candidate that has just completed an application may receive a higher “freshness” factor (e.g., may be queued higher) than a candidate that has been in a queue for two months. In still other embodiments, a reverse freshness factor may be applied so that candidates that have been in the queue longer than other candidates may receive preferential consideration (e.g., a higher queue score).

One embodiment includes a dynamic candidate queuing system. The dynamic candidate queuing system includes a network comprising a server communicatively coupleable with one or more other computers. The server includes a processor and a storage device coupled to the processor. The server is configured to receive data entered at the one or more other computers by candidates and store the data in the storage device. Further, the processor generates a queue listing of candidates in the storage device and the queue listing is organized according to a score given to the data.

Another embodiment is a method of ranking candidates for a job position. The method includes administering a skills assessment test to a candidate and scoring the skills assessment test. In some embodiments, the skills assessment test may include skills testing as well as personality testing. The skills assessment test results in a quantifiable (e.g., numerical) score. Additionally, the method includes providing job specific questions to screen the candidate and scoring the answers to the job specific questions. The score from the skills assessment test is combined with the score from the job specific questions answers and the candidate is inserted into a queue relative to other candidates based on the candidate's combined score.

In yet another embodiment, a recruiting method includes administering screening questions to a candidate and scoring the candidate's answers to provide a first score. Additionally, a skills assessment is administered and scored to provide second score. The first and second scores are combined and the candidate is placed in a queue based on the combined score.

In still another embodiments, a dynamic candidate organization system is provided that includes a network comprising a server communicatively coupleable with one or more computing devices. The server has a processor and a storage device coupled to the processor. The server receives data entered at the one or more other computers by candidates and stores the data in the storage device. The processor compares the received data with job related metrics and organizes candidates into a plurality of tiers based on each candidate meeting job related metrics for a particular tier.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and detailed description are to be regarded as illustrative in nature and not restrictive.

### BRIEF DESCRIPTION OF THE DRAWINGS

FIG. 1 illustrates a computer network recruiting system.

FIG. 2 illustrates a server of the computer network recruiting system of FIG. 1.

FIG. 3 is a flowchart illustrating a method for operating the computer network recruiting system of FIG. 1.

FIG. 4 illustrates a storage device of the server of FIG. 2 as having multiple queues with ranked candidates.

FIG. 5 illustrates the multiple queues of FIG. 4 after a new candidate enters the candidate pool.

FIG. 6 is a flowchart illustrating another method for operating the computer network recruiting system of FIG. 1.

FIG. 7 is a flowchart illustrating a method of organizing candidates within a tiering system.

### DETAILED DESCRIPTION

Systems and methods for organizing job candidates are discussed herein. Specifically, a system is provided that dynamically organizes job candidates into a queue based on one or more criteria (e.g., scores) achieved by the candidate. The score may generally be based upon a variety of factors including the candidate's interests, work experience, education, location, skills, preferences and so forth. Further, the score may be variable based on the particular position that is being filled. That is, a particular candidate may have a different score for different positions, even though information in the user's profile is unchanged. This is due, in part, to the two positions having different requirements/preferences and a weighting system associated with the positions.

The queuing system is dynamic; it is possible for candidates to move on and off and back on a queue. For example, initially the candidate may enter the queue, be selected and interviewed for a job and, upon interviewing (or at another point for some other reason), may be removed from the queue. If the candidate declines the job, the candidate may reenter the queue. In some embodiments, the candidate may subsequently reenter the queue, for example, if a new job is listed (e.g., having different shift times, different requirements, and so forth).

In some embodiments, a single queue may order all candidates based on a raw score. In other embodiments, each position or program may have a unique queue and the ranking/organization of candidates within the pool is based on a multi-variant analysis of the candidate and the positions that are available. The queues are dynamic based on the pool of candidates in the queue. That is, the queues are not necessarily first-in-first out, rather the candidate with the highest score in each queue is placed at the top of the queue, regardless of when that candidate submitted information for consideration. Thus, the candidate that has the highest score for each queue is the first candidate that receives consideration.

Additionally, some embodiments may incorporate a diverse weighting system for each unique position. That is, certain response given by the candidate may be more favorably weighted and others less favorably weighted based on the requirements/preferences for the particular position. For example, foreign language skills may be preferred for a first position and not necessary or preferred for other positions. As such, an indication of foreign language skills may be weighted heavier (e.g., given a higher score) for the first position as opposed to other positions.

In still other embodiments, a tiering system may be implemented that places candidates in one or more of a plurality of tiers if the candidate meets criteria or metrics for a tier. In some cases, qualification for a higher qualifies the candidate for lower tiers. Alternatively, in some cases, each candidate may be placed in only a single tier. It should be appreciated that the tiering system may be implemented independently from or in combination with the queue system.

Further, each of the queuing system and the tiering system may be applied to a candidate pool for multiple entities and/or for multiple different jobs. That is, a candidate may complete a process once and be placed in a queue and/or tier that is considered by multiple employing entities and/or multiple job postings for a single entity. As such, in some embodiments, the scoring of a candidate may initially qualify the candidate for consideration for multiple positions at multiple different employers. Further queuing and/or tiereing may be performed by each employer or for each unique job posting.

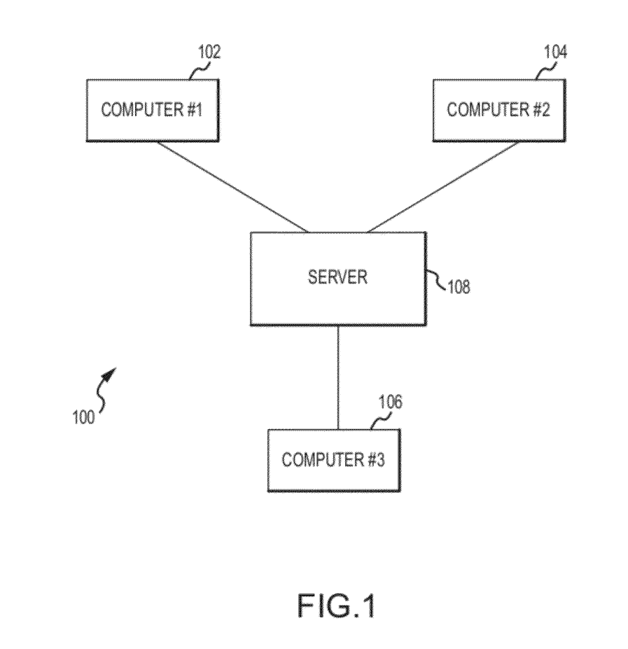

FIG. 1 illustrates a placement network 100 having a plurality of computing device 102, 104, 106. The computing device 102, 104, 106 may be accessible by candidates in geographically separate locations, in some embodiments, while in other embodiments one or more computing devices 102, 104, 106 may be co-located. The computing devices 102, 104, 106 may be owned by candidates or they may be owned and controlled by an employer.

The computing devices 102, 104, 106 are in communication with a server 108. Specifically, the computing devices 102, 104, 106 are in network communication with the server 108, such as via a local area network, a wide area network, the Internet, and/or so forth. Moreover, the computing devices 102, 104, 106 may be communicatively coupled with the server 108 via wired (e.g., CatV cable) and/or wireless communication modes (e.g., WiFi).

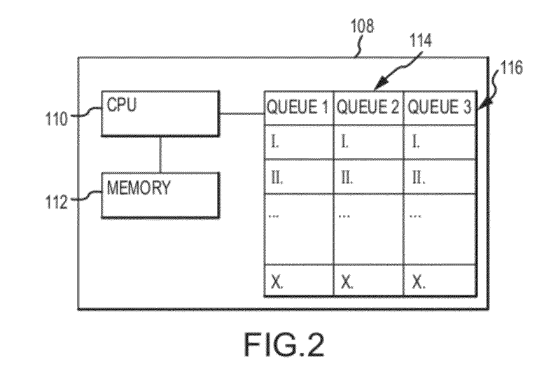

A block diagram of the server 108 is illustrated in FIG. 2. The server 108 includes a processor 110 and a memory 112 coupled to the processor. The processor 110 may include one or more processing units and/or processing units with one or more processing cores. The memory 112 may take any suitable form of memory, such as random access memory (RAM), including dynamic RAM, synchronous dynamic RAM, and so forth.

Additionally, the server 108 includes a storage device 114. In some embodiments, the server 108 may house the storage device. In other embodiments, the storage device 114 may be remotely located from the server 108, but in electronic communications therewith. The storage device 114 may take any suitable form including hard disk drives, semiconductor drives, magnetic tape drives, light drives, and so forth. The storage device 114 may store candidate information, such as contact information, resume information. Additionally, the storage device 114 may include one or more queues 116. The queues 116 may store an organized listing of candidates based on a score achieved by answering questions, such as a screening questions and/or a skills assessment test (which may test aptitude in one or more skill areas). One example of a skills assessment test program is PROVISOR, although other programs, techniques and methods may be freely used. Each queue 116 may be job specific and may organize the candidates in an order based on the score that suggests those candidates that may be best suited to fill the job related to that queue.

The queues 116 are dynamic in that they may change based on a variety of factors including a new candidate entering the queue, a candidate leaving the pool, updating a candidates profile and/or updating or changing the job criteria.

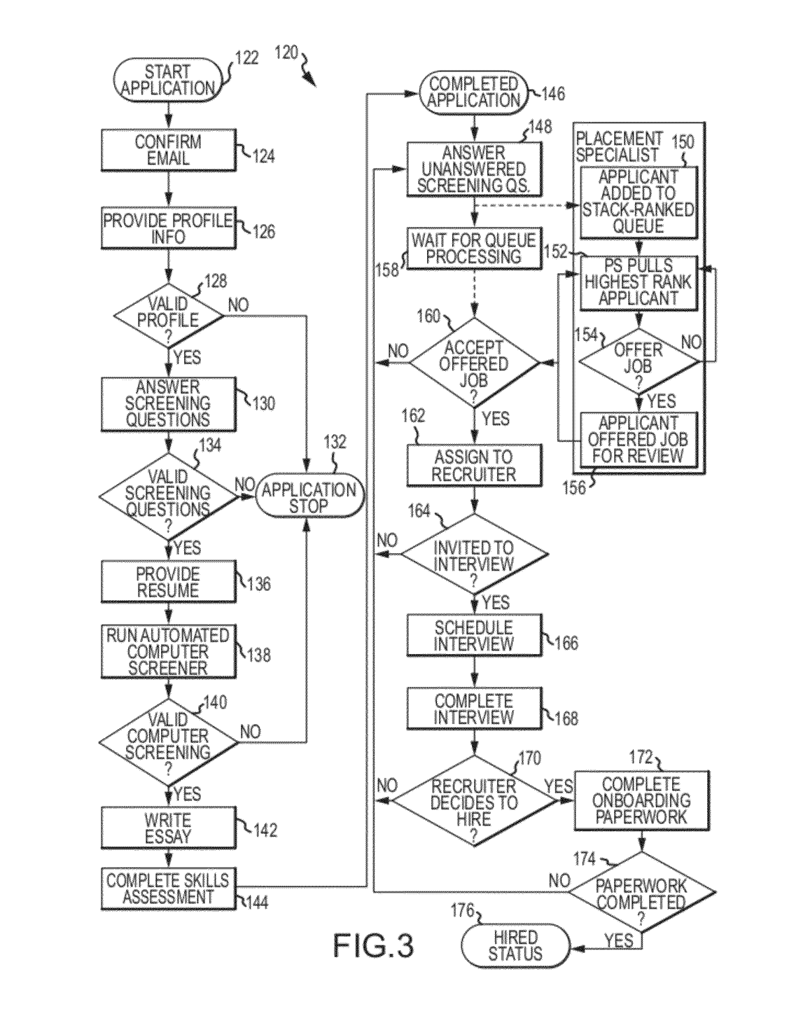

FIG. 3 is a flowchart illustrating an example method 120 of applying for a job by a candidate and the corresponding method of ranking the candidate within a queue. Initially, a candidate may start and application (Block 122) and confirm contact information, such as an email (Block 124). The candidate may have an opportunity to provide profile information (Block 126) which may include information such as name, location (address), phone number, time zone, languages spoken, and so forth. The profile is checked for completion and/or accuracy (Block 128). If the profile is invalid, the application may stop (Block 132), although in other embodiments, the candidate may have the opportunity to correct errors/omissions in the profile and continue forward once they are corrected.

If the profile is valid, screening questions may be asked (Block 130). The screening questions may include, but are not limited to: Can you provide proof of eligibility to work in the U.S.? Do you have a high school diploma or graduation equivalency degree (GED)? Are you at least 18 years old? Have you previously been employed with X employer? Do you have simultaneous access to Internet and phone without the use of a cell phone? What computer operating system is used in home? Have you ever been convicted of a felony? What is your highest level of education? Do you have experience in a particular field(s) (e.g., experience as a banker, a call center employee, customer service, retail sales, technical support, and so forth)?

In some instances a particular answer to one or more screening question may prompt a follow-up question. Some of the questions may be answered by selection of one of two or more provided answers. Once a user is ready to exit the screening questions, the answers are checked to determine if valid answers have been provided and/or that there are no omitted answers (Block 132). If the answers are not valid, the application may be stopped (Block 132), while in other embodiments, the candidate may be permitted to return to the questions and correct any noted errors.

If the screening questions are valid, the candidate may be given an opportunity to provide a resume (Block 136). In some embodiments, the resume may be uploaded, while in other embodiments the user may fill in experience and education information in an open text field. A computer screen may be run (Block 138) and it is determined if the computer screening was valid (Block 140). If the computer screening fails, the application may stop (Block 132). Additionally, the candidate may have the opportunity to write an essay (Block 142) and complete a skills assessment (Block 144). The skills assessment may include both general skills and/or job specific skills. For example, a typing speed may be tested or specific knowledge of key concepts related to a job may be tested. Once the steps are complete, the application may be completed (Block 146) and an opportunity may be provided for the candidate to answer any unanswered screening questions (Block 148).

The candidate's application is then given a score. The score may be given on a per job basis. That is, the score may reflect a candidate's quality or qualifications for a particular job. In other embodiments the score may be an overall score. Specifically, the score may represent a candidate's overall qualifications. As may be appreciated, the different embodiments may be carried out in different ways. For example, in some embodiments, each job may have a unique queue and the candidates are ranked within each queue based on their score. As such, a candidate's quality may only be in reference to a particular job. In other embodiments, a single queue may rank all candidates for all jobs based on their score.

In some embodiments, at this point, the candidate is provided an opportunity to accept or reject terms of a job and, after accepting the terms of the job, they are added to the queue. If they decline the terms of the job, they may not be added to a queue. In other embodiments, the candidate may be added to a stack ranked queue (Block 150), such as queues 116, before accepting the terms. The queue may be accessed by a placement specialist who may select the highest ranked application (Block 152). In particular, the placement specialist may have access to the server 108 in order to review candidate profiles and to pull information of the candidates, such as the information of those candidates listed at the top of the queues. This facilitates, the placement specialist deciding whether to have a particular job presented to the candidate (Block 154). If the placement specialist decides not to make a particular job available, the placement specialist may pull another candidate's profile, e.g., the profile of the next highest ranked candidate (Block 152). If the placement specialist decides to make a job available to the candidate, the job is presented to the candidate, for example via email or other suitable communication mode (Block 156) and the placement specialist may pull the profile of the next candidate from the queue for consideration.

While the candidate's application is ranked and added to the queue, and then considered by the placement specialist, the candidate may wait for the queue processing (Block 158) until a job is presented to the candidate for consideration and the candidate may accept or reject the presented job (Block 160). If the candidate rejects the job, the candidate may return to answer unanswered questions or change a portion of the profile (Block 148). The candidate then waits (Block 154) until another job is presented. As may be appreciated, in this embodiment, the candidate may not have the opportunity to review and/or select a job opening until it has been offered to them. That is, the candidate may not be able to view a job opening until the placement specialist selects the candidate from the queue.

If the candidate accepts the job opening that is presented, the candidate may be assigned to a recruiter (Block 162). The recruiter assignment may be automated by the server 108. That is, the server 108 may maintain a database listing potential recruiters and their availability and may align the candidate with a recruiter that has mutual availability and is qualified to act as a recruiter for the particular position for which the candidate was selected. In some embodiments, the recruiter assignment may be made in a round-robin manner for qualified recruiters' availability. A qualified recruiter may be one that is qualified for the particular job, works with a particular group that is hiring, and so forth. In still other embodiments, the recruiter may be assigned based on filling one recruiter's schedule before assigning candidates to another recruiter, and so on.

The recruiter may review the candidate's application and decide whether to invite the candidate for an interview (Block 164). If the candidate is selected for an interview, the interview is scheduled (Block 166) and the interview is conducted (Block 168). After the interview, the recruiter may decide to hire the candidate or not (Block 170). If the candidate is selected for hiring onboarding paperwork may be completed by the candidate (Block 172). It is determined if the paperwork is completed (Block 174). If the candidate fails to complete the paperwork within a specified time frame the candidate's application may be returned to have the candidate answer screening questions (Block 148) and wait for queue processing (Block 158). In some embodiments, upon failure to complete on boarding paperwork, the candidate may be asked to provide information as to why the paperwork was not completed. If the paperwork is completed, the candidate is hired and the candidate's application may be placed in a hired status (Block 176). In the hired status, the candidate's application may be removed from the queues but saved for future reference and for possible consideration for promotion and/or other positions.

As may be appreciated, although the flow chart 120 included input from the candidate, the placement specialist, and the recruiter, while the server 108 provided the structure to the process. Specifically, in some embodiments, the server 108 may provide the candidate, the placement specialist, and the recruiter with a graphical user interface with which each of the they may interact and provide input. Moreover, in some embodiments the process may be automated. For example, the server 108 may store all the information input by the users to facilitate review and processing of the information.

Further, the server 108 may be configured to perform the ranking function of the candidates and the positioning of the candidates within the queues. Specifically, in one embodiment, a raw score calculated from the screening questions may be added to a raw score from the skills assessment exam. In some embodiments, the score from the skills assessment exam may be weighted heavier than the score from the screening questions, or vice-versa. In other embodiments, only a score from the skills assessment exam may be used. In still other embodiments, additional criteria for scores may be applied (e.g., applicant behavior in the system, applicant freshness, reverse applicant freshness, and so forth). The freshness and the reverse freshness factors may be applied based on one or more threshold time periods being achieved/surpassed. For example, a candidate may be considered fresh if the candidate's application is less than two weeks old or has been modified within two weeks. Reverse freshness may be applied when a candidate's application has not been selected from a queue for consideration for more than four weeks, for example.

As mentioned above, a weighting system may be provided for the ranking. That is, certain answers to screening questions may be given a better score than others (e.g., may be given greater weight). For example, in some embodiments, fluency in a language other than English may receive a score of “2” whereas fluency in English may receive a score of “1” and fluency in both languages give s score of “4.” Accordingly, the bilingual skill may be rewarded as it may provide greater communication ability for a more diverse clientele. In another example, location of the candidate may be weighted based on the state in which the candidate resides. For example, a candidate residing in Colorado may receive a score of “1” while a candidate in Virginia may receive a score of “0.75”.

Moreover, multiple attributes may be considered/merged to produce a score for answers to one or more questions. For example, a candidate may be given a score of “1′” if they indicate that they have completed some college. If, however, they indicate they have completed some college and have a skills assessment greater than some threshold (e.g., greater than 50), they may be given a score of “2” for the indication of having completed some college. Hence, multiple factors may be merged together to produce a single score instead of weighting on a single attribute. Furthermore, screening questions may be used as a weighted score and as an absolute gate (e.g., they may be used to prohibit access to a queue if a minimum requirement is not met).

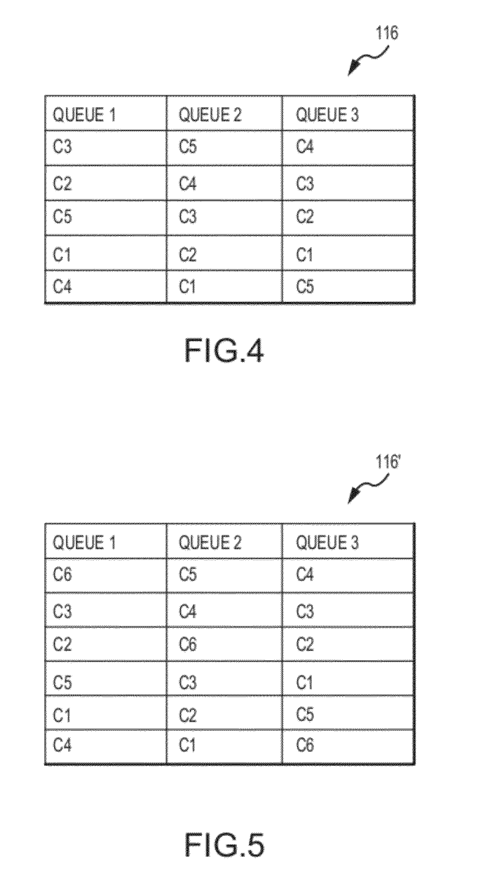

The weighting of certain attributes/skills/characteristics may be determined based on a variety of factors including, the type of work that will be involved, the time zone in which regular working hours will be expected, and so forth. The weighting may be manually set based on internal criteria and/or the requirements of the job. That is, the server 108 may organize the queues 116 the candidates in the queues based on job specific selection criteria and/or based on the qualifications of the candidates, as will be discussed in greater detail below. As such, the queues 116 while including the same pool of candidates may rank/organize the candidates in entirely different order. This is illustrated in FIG. 4. Hence, each queue 116 may be job specific and may organize the candidates in an order to best fill the job related to that queue. As an example, Queue 1 may list the candidate 3 (C3) and first while Queue 2 lists candidate 5 (C5) first and candidate 2 (C2) as third. The listing at the top or front of the queue indicates that the candidate through objective and/or subjective measures is likely a better candidate for the position based on the desired criteria for the position.

FIG. 5 illustrates the entry of a new candidate 6 (C6) into the queue 116′. As may be seen, based on the qualifications of C6, the candidate is inserted into different locations with the respective queues. Thus, the queues are dynamic based on the entry of new candidates (or the exit of candidates from the pool). Additionally, the queues may change based on an updated candidate profile and/or the updating of the job requirements. The updating of a candidates profile may occur based on user input, and/or an updated test taken by the candidate. Criteria for the job may update based on additional information provided by an employer and/or an updated weighting of a user's characteristics/qualifications for the job. Generally, certain characteristics, qualifications and/or skills may be desirable for certain jobs. The desirable attributes may be emphasized by scoring attributes and providing greater weight for those attributes. In some embodiments, a raw score for a certain attribute may be higher than other attributes. In other examples, a multiplier may be provided for certain attributes so that they are weighted heavier.

In some embodiments, a “tier” based ranking may be implemented. Generally, applicants may be assigned a “tier” (which may be a score or may include a range of scores) for any job in the system based on a minimum skills assessment score and/or answers to the screening questions. In other embodiments, other factors may be included in the score determining tier. The tiers may or may not overlap. A candidate in a higher tier may qualify for all lower tiers. That is, if a candidate qualifies for Tier 1 (e.g., the best tier), then that candidate may also be qualified for Tiers 2 and 3. Alternatively, a candidate can qualify for Tier 1 without qualifying for Tier 2. For example, in some instances, a particular candidate may qualify for a first tier but may be considered overqualified for a second tier. The tiers may be defined using a multi-factor analysis for a particular job.

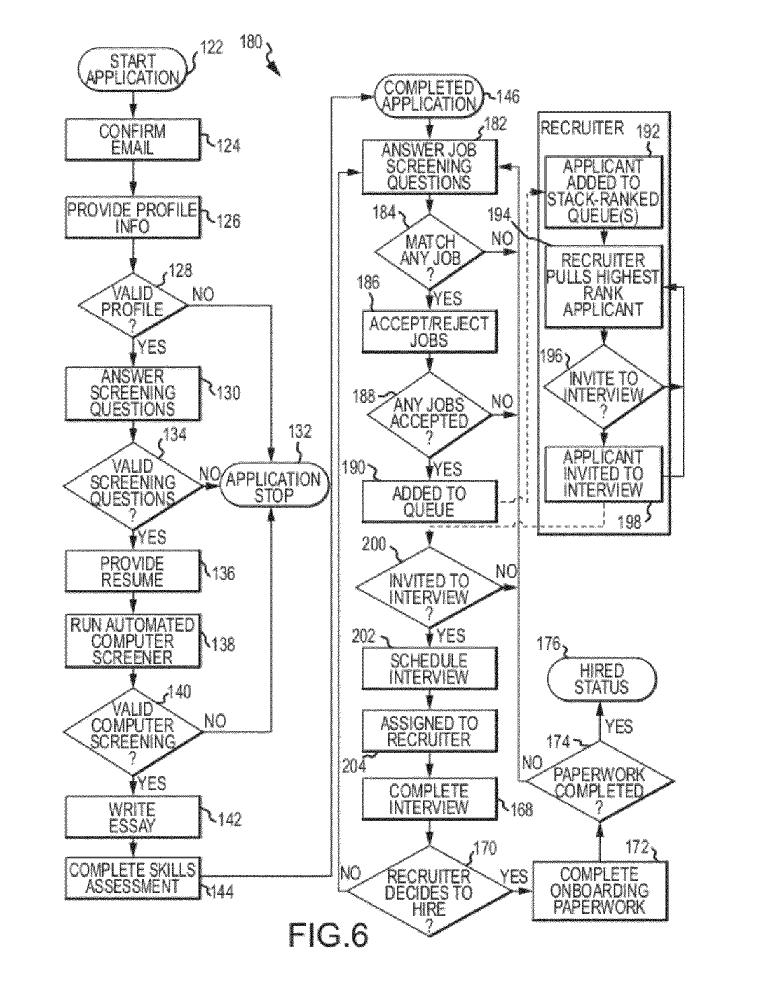

FIG. 6 is a flowchart illustrating an example method 180 of applying for a job by a candidate and the corresponding method of ranking the candidate within a queue(s). Generally, steps 122-146 and 168-176 correspond with the same steps in FIG. 3 and as such will not be discussed further.

In the method 180, upon completion of the application (Block 146), the candidate may be asked job screening questions (Block 182). The job screening questions may be targeted to gauge the interest and/or aptitude of the candidate relative to specific positions. Upon answering those questions, it is determined if the candidate's answers match any jobs (Block 184). If not, the candidate may return to the job screening questions and change answers to expand the number of jobs that may match the answers. If there are jobs that match, the candidate has the opportunity to accept or reject the jobs (Block 186). It is determined if any jobs were accepted by the candidate (Block 188). As such, the candidate may have the opportunity to review certain job postings and agree to certain conditions/requirements for the position in order to be placed in the queue for a particular position.

If the candidate accepted a job listing, the candidate is added to the pool of candidates in the queue related to the accepted job (Block 190). When the candidate is added to the queue the candidate is ranked within the queue relative to the other candidates based on a multi-variant score that accounts for the candidate's qualifications and skills, as well as the requirements of the job. Additionally, for some positions, analytics are applied to the user profile to further refine the scoring. In some embodiments, a bell curve may be applied with associated statistical analysis that may indicate the probability that the candidate may be retained long term or may leave the position after a short period. Some metrics that may be included in the statistical analysis may include a level of education, a period in which the candidate has lived in a particular area, the experience of the candidate, and so forth. For example, with respect to the level of education of the candidate, in some cases a higher level of education may be viewed favorably for long term retention of the employ as the job may pay well and provide desirable working conditions. For other positions, a higher level of education may be unfavorable, as it may indicate ambition which would likely lead to the candidate leaving the position as soon as another opportunity arose elsewhere.

The statistics and metrics used in ranking of the candidate may be developed empirically based initially upon a current work force (if available) or based on a “best” guess by those trying to fill a position. Over time, the characteristics/qualifications of candidates/employees that fill the open position and similar positions may be audited to better understand what factors are statistically significant factors in developing the long term employee relationship. Upon finding these factors, job screening questions may be developed to target these factors and answers related to those factors may be weighted heavier than other answers.

Referring again to FIG. 6, the recruiter may select the highest ranked applicant from the queue (e.g., the first applicant in the pool) for consideration (Block 194). The recruiter may review the candidate's application and make a decision to interview the candidate (Block 196) or retrieve the next candidate from the queue. It should be appreciated that other dispositions may be available to the recruiter. For example, the recruiter may be able to select “do not invite to interview,” if a particular red-flag is seen by the recruiter, and may be able to insert a related comment in the candidate's profile. Further, in some embodiments, the recruiter may be able to “reject” the candidate from any further consideration for any job, thus eliminating the candidate from all queues and from future entry into queues. Additionally, the recruiter may be able to reject the candidate for a particular job being considered but the candidate may remain in other queues.

If the candidate is selected for interview (Block 198), the candidate may be invited to an interview (Block 200) and an interview may be scheduled (Block 202). Additionally, the candidate may be assigned to a recruiter (Block 204) and the interview is conducted (Block 168). The recruiter may perform the interview or part of the interview with the candidate, in some embodiments. The remainder of the steps is substantially similar to those of FIG. 3.

As may be appreciated, the queue ranking system presented herein may help facilitate an efficient recruiting process for both an employer and candidates for employment. Much of the system may be automated, including the ranking of candidates in the queue(s), presenting of screening questions, the skills assessment test, general screening questions, the scheduling of interviews, and so forth. Furthermore, the multi-variant and statistical analysis may allow for targeted hiring that may provide for higher retention rates as well other favorable results.

A tiering system may be implemented independently from or in conjunction with the queue ranking system discussed above. The tiering system may, for example, be implemented after job screening questions are answered (e.g., FIG. 6, Block 182). Generally, the tiering system may take the form of an iterative process that places candidates in a tier or level based on their qualifications and/or skills. In some embodiments, the tiering system may be implemented over a number of different possible job openings and may include a pool of candidates that may be eligible for those jobs. In another embodiment, the tiering system may be implemented on a job-by-job basis. That is, each job may have its own tiering system that helps to organize the candidates in the pool for that particular job.

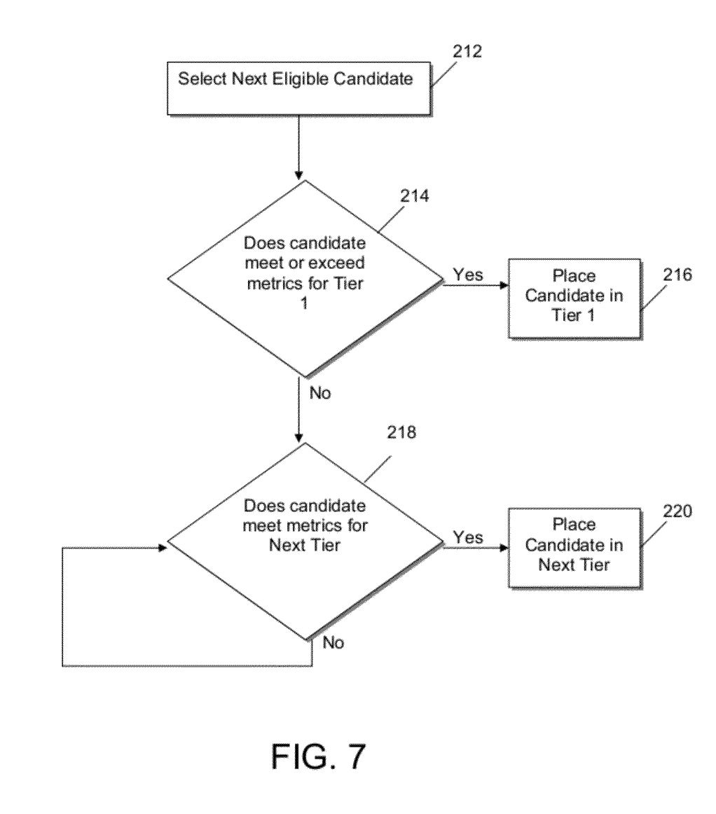

Turning to FIG. 7, a flowchart 210 illustrates the method of implementing the tiering system. A next eligible applicant is received into the tiering system (Block 212). The applicant is compared against the metrics of the first tier (Block 214). If the applicant meets or exceeds the metrics of the first tier, then the applicant is placed in the first tier (Block 216). If however, the applicant does not meet the metrics of the first tier, then the applicant is compared against a next tier (Block 218). If there applicant meets the metrics of the tier, then the applicant is placed within that tier (Block 220). If, however, the application does not meet the metrics of the tier, the process continues, moving to the next tier until the applicant is placed in a suitable tier.

It should be appreciated that the tiering may occur at any suitable time in the process. For example, tiering may occur or be repeated upon a change in a job description, upon a change in the applicant's file, in response to a changed answer to a question, and so forth. In the case of a change in the applicant's file, the tiering may occur upon submission of the change. In the case of the change in a job description or job requirement, the tiering may occur as a batch tiering of all applicants in the hour, day, week or other time after the change.

As may be appreciated, the metrics for each tier may be determined based on requirements for a particular job. Language skills, typing skills, computer skills and so forth may be useful metrics for setting tier levels. For example, if a particular job requires English and Spanish proficiency, then a top tier (e.g., Tier 1) may only include those applicants that have such proficiency. Additionally, bilingualism may be preferred even if it is not Spanish/English and, as such, Tier 2 may include applicants that meet other metrics and are bilingual in languages other than Spanish/English. Another job may prefer bi-lingual proficiency, but not require Spanish/English bilingualism so that first and second tiers include bilingual candidates that are differentiated between the two tiers based on other metrics pertinent to the job.

In some embodiments, the tiering may be used in combination with the queue system. For example, candidates within each tier may be ordered in accordance with a score. In still other embodiments, the tiers may be applied to a queue after the queue has been organized. As such, the tiers and the queue may be used in combination or independently.

The foregoing describes some example embodiments to achieve a dynamic candidate queuing system. Although the foregoing discussion has presented specific embodiments, persons skilled in the art will recognize that changes may be made in form and detail without departing from the spirit and scope of the embodiments to achieve the similar security provided by the embodiments disclosed herein. Accordingly, the specific embodiments described herein should be understood as examples and not limiting the scope of the disclosure.

1. A dynamic candidate queuing system comprising:
a network comprising a server communicatively coupleable with one or more other computers, the server comprising:
a processor; and
a storage device coupled to the processor, wherein the server is configured to receive data entered at the one or more other computers by candidates and store the data in the storage device;
wherein further the processor generates a queue listing of candidates and the queue listing is organized according to a score given to the data.

2. The dynamic candidate queuing system of claim 1, wherein the score is based at least in part upon job specific factors.

3. The dynamic candidate queuing system of claim 1, wherein the score comprises a combination of multiple scores from at least two of: a skills assessment test, one or more screening questions, behavior in the system, and a freshness factor.

4. The dynamic candidate queuing system of claim 1, wherein the score comprises at least two attributes merged together to produce a score for a single answered question.

5. The dynamic candidate queuing system of claim 1, wherein the score comprises a sum of one or more weighted scores that are weighted based upon their relevance to a particular job.

6. The dynamic candidate queuing system of claim 1, wherein the queue listing comprising a plurality of queues, each queue corresponding to a different job position.

7. The dynamic candidate queuing system of claim 6, wherein one or more of the plurality of queues include two or more common candidates.

8. The dynamic candidate queuing system of claim 7, wherein in at least one of the plurality of queues has a different ordering of the two or more common candidates.

9. A method of ranking candidates for a job position comprising:
administering a skills assessment test to a candidate;
scoring the skills assessment test;
providing job specific questions to screen the candidate;
scoring the answers to the job specific questions;
combining the score from the skills assessment test with the score from the job specific questions answers; and
inserting the candidate into a queue relative to other candidates based on the candidate's combined score.

10. The method of claim 9 further comprising computing a weighted score for the skills assessment test.

11. The method of claim 9 further comprising weighting one or more answers of the skills assessment test.

12. The method of claim 9 further comprising weighting answers to the job specific questions such that they carry more weight relative to the skills assessment test.

13. The method of claim 9 further comprising performing a statistical analysis on a candidates answers to the job specific questions.

14. The method of claim 9 further comprising modifying an answered question's scoring based on a score given to at least one other answered question.

15. A recruiting method comprising:
administering screening questions to a candidate;
scoring the candidate's answers to provide a first score;
administering a skills assessment;
scoring the skills assessment to provide second score;
combining the first and second score;
placing the candidate in a queue based on the combined score; and
modifying the combined score based on at least one of: candidate activity and candidate freshness.

16. The recruiting method of claim 15 further comprising providing the first candidate in the queue for consideration for a job prior to other candidates in the queue.

17. The recruiting method of claim 15 further comprising:
administering job screening questions;
scoring answers to provide a third score; and
combining the third score with the combined score.

18. The recruiting method of claim 17 further comprising weighting the third score more heavily than the first or second scores.

19. The recruiting method of claim 17 further comprising modifying at least one of the first, second or third scores based on at least one of the other scores.

20. The recruiting method of claim 17 further comprising:
providing a description of a job that corresponds with answers provided in response to the job screening questions; and
receiving input from the user as to whether the candidate accepts the job as one holding interest for the candidate.

21. The recruiting method of claim 19 further comprising placing the candidate in a queue corresponding to the job if the user accepts the job.

22. The recruiting method of claim 15, wherein the candidate is placed in one of a plurality of tiers based on one or more of the skills assessment score and the screening questions score.

23. The recruiting method of claim 22, wherein the plurality of tiers are mutually exclusive.

24. The recruiting method of claim 22, wherein qualification of the candidate to a first tier qualifies for at least one lower tier.

25. A dynamic candidate organization system comprising:
a network comprising a server communicatively coupleable with one or more computing devices, the server comprising:
a processor; and
a storage device coupled to the processor, the server receiving data entered at the one or more other computers by candidates and storing the data in the storage device;
wherein the processor compares the received data with job related metrics and organizes candidates into a plurality of tiers based on each candidate meeting job related metrics for a particular tier.

26. The system of claim 25, wherein the server stores information related to one or more jobs.

27. The system of claim 26, wherein each of the one or more jobs has a unique plurality of tiers.

28. The system of claim 26, wherein the plurality of tiers is for all of the one or more jobs.

29. The system of claim 26, wherein candidates in a first tier are first considered for placement.

30. The system of claim 25, wherein the processor generates a queue listing of candidates and the queue listing is organized according to a score given to the data.
